(19) United States
(12) Patent Application Publication
(10) Pub. No.: US 2014/0195256 A1
(43) Pub. Date: Jul. 10, 2014

(54) Workflow Context Aware Location Tracking System And Method

(71) Applicant: Awarepoint Corporation, (US)

(72) Inventors: Cory Wagner, Matthews, NC (US); Chad Sallee, Waxhaw, NC (US); Matthew R. Perkins, San Diego, CA (US); Wei Geng, San Diego, CA (US); Brian Wicks, San Diego, CA (US)

(73) Assignee: AWAREPOINT CORPORATION, San Diego, CA (US)

(21) Appl. No.: 13/798,081

(22) Filed: Mar. 13, 2013

Related U.S. Application Data
(63) Continuation-in-part of application No. 13/646,640, filed on Oct. 5, 2012.
Application No. 13/646,640 is a continuation of application No. 12/484,236, filed on Jun. 14, 2009, now Pat. No. 8,285,564.
(60) Provisional application No. 61/166,755, filed on Apr. 5, 2009.

(51) Int. Cl. G06Q 50/22

(52) U.S. Cl. CPC G06Q 50/22; G06Q 10/0633
USPC 705/2; 705/7.27

(57) ABSTRACT

A system and method for improving tracking indoor or outdoor object movement using workflow context information. The system comprises a location tracking sub-system, communication devices and a context-aware location engine. The context-aware location engine is configured to receive from the location tracking sub-system a plurality of initial location estimations for the communication devices and generate a plurality of filtered location estimates for the communication devices.

### CROSS REFERENCES TO RELATED APPLICATIONS

The present application is a continuation-in-part application of U.S. patent application Ser. No. 13/646,640, filed Oct. 5, 2012, which is a continuation application of U.S. patent application Ser. No. 12/484,236, filed on Jun. 14, 2009, now U.S. Pat. No. 8,285,564, issued on Oct. 9, 2012, which claims priority to U.S. Provisional Patent Application No. 61/166,755, filed on Apr. 5, 2009, now abandoned, all of which are hereby incorporated by reference in their entireties.

### STATEMENT REGARDING FEDERALLY SPONSORED RESEARCH OR DEVELOPMENT

Not Applicable

### BACKGROUND OF THE INVENTION

1. Field of the Invention

The present invention is related to wireless tracking systems and methods. More specifically, the present invention relates to a system and method utilizing context aware location tracking.

2. Description of the Related Art

Real-time knowledge of resources, whether the resources are assets or people, is becoming a necessary tool of many businesses. Real-time knowledge of the location, status and movement of crucial resources can allow a business to operate more efficiently and with fewer errors. However, many businesses employ hundreds if not thousands of resources in a single facility, and these resources need to be accounted for by a central system that is user friendly.

For example, in a typical hospital there are numerous shifts of employees that utilize the same equipment. When a new shift arrives, the ability to quickly locate medical equipment not only results in a more efficient use of resources, but also can result in averting a medical emergency. Thus, the tracking of medical equipment in a hospital is becoming a standard practice.

The tracking of objects in other facilities is rapidly becoming a means of achieving greater efficiency. A typical radio frequency identification system includes at least multiple tagged objects, each of which transmits a signal, multiple receivers for receiving the transmissions from the tagged objects, and a processing means for analyzing the transmissions to determine the locations of the tagged objects within a predetermined environment. Further, the ability to not only track but analyze resources would further improve efficiencies.

The prior art discloses various tracking systems and uses of near-field communication devices. Near field communication typically operates in the 13.56 MHz frequency range, over a distance of one meter or less and usually a few centimeters. Near field communication technology is standardized in ISO 18092, ECMA 340, and ETSI TS 102 190.

One reference discloses an adapter for a tag that is configured to emulate a near filed communication reader-to-reader tag.

Another reference discloses a medical diagnostic system that includes a data acquisition device having a near field communication device for transfer of data.

Still another reference discloses using ECMA 340 standard for near field communication.

Another reference discloses a system for monitoring a patient that uses a personal status monitoring device, such as an ECG electrode assembly, which transmits a signal to an intermediary device, such as a PDA, which transmits to a server using a WLAN.

Another reference discloses an object identifier that transmits both an IR signal and a RF signal for location determination.

Another reference discloses a system which allows for a location to be determined without requiring precise calculations through use of an object identifier that transmits one identifier corresponding to an object identifier and a second identifier which is a group identifier.

Another reference discloses a system for recording object associations based on signals for object identifiers.

Another reference discloses a system that uses NFC technology to determine a secondary transport mechanism.

Another reference discloses a system that uses BLUETOOTH technology integrated in a cellular telephone to provide interpersonal communications between individuals.

Another reference discloses near field communication devices that determine an efficient protocol for sharing information.

Another reference discloses passing advertising messages to a mobile client using near field communication technology.

Graves et al, U.S. Pat. No. 8,050,939 for Method And Systems For Use In The Provision Of Services In An Institutional Setting Such As A Healthcare Facility, discloses an environmental context processing engine configured to transform sensed data indicative of activity relevant to provision of said service into data indicative of an environmental context in which the activity is deem to have occurred.

Ebert et al, U.S. Pat. No. 7,969,9306, for a Context-aware And Real-Time Item tracking System Architecture And Scenarios, discloses using received tag data and context information to maintain virtual items and virtual circumstances in a virtual world.

As stated above, the problem is inadequate resource visibility in a business. Businesses such as hospitals, need to locate resources (assets and people), know the status of the resources, and understand the usage history of the resources to enable business improvement.

Specific problems for hospitals include tracking infections in a hospital to determine a source and other areas or individuals that may be infected. Other problems include spotting emerging patterns of infection and outbreaks to mitigate those affected. Further, for MEDICARE and other insurance providers, hospitals and other medical facilities need to demonstrate that patients received their required care in order to receive payment for such care. The prior art has failed to provide an adequate solution to these problems.

Further, there is a need in the health care market to determine when interactions occur between patient worn devices and clinician worn devices. Being able to detect this interaction will drive many applications that revolve around workflow, patient flow and asset tracking To enable the detection of these interaction events, a communication protocol must be defined such that the tags will recognize when they are in-range of each other and report on the in-range event. Off-the-shelf technologies can be employed for this use case but the battery-life, communication range and data rate requirements are often traded for communication performance. For example, peer-to-peer WiFi could be used to establish a near-real time connection between two devices but the battery life of the WiFi-enabled device would be on the order of 1-2 days which would not support the application need. Many other technologies have the same drawbacks.

The prior art has failed to provide a robust system for generating location estimations for a workflow.

### BRIEF SUMMARY OF THE INVENTION

The present invention utilizes a context aware location tracking engine to generate location estimations for a workflow.

One aspect of the present invention is a system for improving tracking indoor or outdoor object movement using workflow context information. The system comprises a location tracking sub-system, a plurality of communication devices and a context-aware location engine. The location tracking sub-system comprises a plurality of sensors located in a facility for real-time location tracking of persons and/or objects. Each of the plurality of communication devices is associated with an object or a person. Each of the plurality of communication devices is configured to transmit a signal to at least one of the plurality of sensors. The context-aware location engine is in communication with the location tracking sub-system. The context-aware location engine is configured to receive from the location tracking sub-system a plurality of initial location estimations for the plurality of communication devices and generate a plurality of filtered location estimates for the plurality of communication devices.

The context aware location engine preferably comprises a standard workflow that is known a priori. The context aware location engine alternatively comprises a standard workflow that is customary. The workflow is at least one of a series of locations, a series of states, a series of dwell times, a series of interactions, a series of emergency department milestones, a series of surgical milestones, or a series of detected events.

More preferably, the series of emergency department milestones is at least one of a physician call, an EMS call, an arrival/sign-in, a nurse saw, a doctor saw, an entered ED, a departed ED, a bed request, a bed check, a bed ready, a fully registered, a triaged, a quick registered, a dispo ordered, and a floor report. More preferably, the series of surgical milestones is at least one of case created, a check-in, a ready for pre-op, a pre-op declined, a pre-op accepted, an arrived pre-op room, a ready for pre-op nurse, a patient prepped, a left pre-op, an inpatient ready, an ED ready, an arrived OR, a procedure start, a procedure end, a ready for PACU, a ready for ICU, a ready for post-op, a PACU decline, a post-op declined, a PACU accepted, a post-op accepts OR and a departed OR.

Preferably, the role of each object associated with each of the plurality of communication devices is maintained and tracked by the context-aware location engine. Preferably, the object is selected from the group of a patient, a nurse, a physician, housekeeping member, a technician, a transport, a room, a fix location asset, and a moveable asset.

In one embodiment, the context-aware location engine is preferably configured to track a location history and a plurality of workflow stages of each the objects being tracked. The facility is a hospital and the plurality of workflow stages of patient under tracking comprises at least one of a patient arrival stage, a patient in preparation for a medical procedure, a patient in a medical procedure stage, a patient in post-medical procedure stage, and a patient departure.

In another embodiment, the context-aware location engine is configured to maintain and track workflow specific usage information about each of a plurality of locations in the facility. The facility is a hospital and the plurality of workflow specific usage of the locations comprise at least one of a patient room, a nurse station, a hallway, a storage room, a clean utility room, a dirty utility room, a hallway, an exit, a stairway, a restroom, and an office.

In another embodiment, the context-aware location engine is configured to maintain and track the real-time user input information of each the objects or persons being tracked. The facility is a hospital and the real-time user input information comprises at least one of staff marking a patient arrival and staff assigning a room to a patient.

In another embodiment, the context-aware location engine is configured to maintain and track a plurality of real-time interactions between moveable and fixed objects under tracking. The facility is a hospital and plurality of real-time interactions between moveable and fixed objects under tracking comprises at least one of staff or patient interactions with fixed known location objects.

In another embodiment, the context-aware location engine is configured to maintain and track a plurality of real-time interactions between moveable and movable objects under tracking The facility is a hospital and plurality of real-time interactions between moveable and moveable objects under tracking comprises at least staff and patient interactions.

A medium range wireless communication format utilized with the system is preferably selected from ZIGBEE communication format, Bluetooth communication format, Low-Power BLUETOOTH communication format, WiFi communication format, Low-Power WiFi communication format, Ultra Wide Band communication format, Ultrasound communication format or Infrared communication format. A short range wireless communication format utilized with the system is preferably selected from a near-field communication format, a low frequency communication format or a magnetic field communication format. Alternatively, the short range wireless communication format is selected from a magnetic induction communication format, 9 kHz communication format, <125 kHz communication format, 125 kHz RFID communication format, 13.56 MHz communication format, 433 MHz communication format, 433 MHz RFID communication format, or 900 MHz RFID communication format.

Each communication device preferably has a low-power, short-range (<1 foot) communication feature that can detect the presence, or absence, of a signal from another device. Short bits of information are preferably exchanged (<256 bits) between devices but such an exchange is not mandatory. RFID systems operating at frequencies of sub-125 kHz, 125 kHz, 433 MHz, 900 MHz, or 2.4 GHz are used with the present invention. The communication devices alternatively transmit at frequencies as low as 5 kiloHertz (“kHz”) and as high as 900 MegaHertz (“MHz”). Other frequencies utilized by the tags for a low-power short-range communication system include 9 kHz, <125 kHz, 433 MHz, and 900 MHz.

Each device preferably contains a low-power, medium-range (1 foot to 30 feet) wireless communication system. Such wireless communication systems include ZIGBEE, BLUETOOTH, Low-Power BLUETOOTH, WiFi or Low-Power WiFi, Ultra Wide Band (“UWB”), Ultrasound and Infrared communication systems. The wireless communication system is used to exchange device specific information after the low-power short-range system has indicated that an interaction has occurred. Those skilled in the pertinent art will recognize that the wireless communication system can also be used independent of the low-power short-range system for other wireless communication applications such as location and tracking, sense and control, building automation, smart energy, telecom applications, consumer building automation, remote control applications, home health care, personal fitness, personal wellness, and many other applications.

Each communication device preferably continuously transmits a beacon signal using the short-range communication protocol. When a beacon signal is received by another communication device, the receiving communication device can respond using the low-power communication circuit and/or it can respond using the medium-power protocol. The medium-power communication system can transfer larger data packets at a higher transmission rate. Data that might be included in a medium-power transmission include device ID, time stamp, location information, user information, software version, and/or protocol version. A medium-power transmission is preferably acknowledged when received by the receiving communication device. Further, at this point either communication device, or both communication devices, can transmit the information from the interaction to the medium-power infrastructure or to a neighboring communication device. Additionally, the communication devices may also elect to store the interaction information and download/transmit the interaction information at a later time.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is schematic view of a system for analyzing a workflow.

FIG. 2 is a multi-floor view of a facility employing a system for analyzing a workflow.

FIG. 2A is an enlarged view of circle 2A of FIG. 2.

FIG. 2B is an enlarged view of circle 2B of FIG. 2.

FIG. 3 is a floor plan view of a single floor in a facility employing the system for analyzing a communication interaction.

FIG. 4 is a block diagram of a flow of information utilizing a system for analyzing a workflow.

FIG. 5 is a block diagram of a flow of information utilizing a system for analyzing a workflow.

FIG. 5A is an illustration of a valid link between communication devices.

FIG. 5B is an illustration of a valid link between communication devices.

FIG. 5C is an illustration of a valid link between communication devices.

FIG. 6 is an illustration of a failed link between communication devices due to a distance between near-field communication devices.

FIG. 6A is an illustration of a failed link between communication devices due to a distance between communication devices.

FIG. 6B is an illustration of a failed link between communication devices due to a distance between communication devices.

FIG. 7 is a floor plan view of emergency room bays in a hospital employing the system for analyzing a communication interaction.

FIG. 8 is a block diagram of a system for determining a real-time location of an object.

FIG. 9 is an illustration of an emergency room bay equipped with a system for analyzing a workflow.

FIG. 10 is an illustration of tracking of a patient at various workflow stages in a healthcare facility.

### DETAILED DESCRIPTION OF THE INVENTION

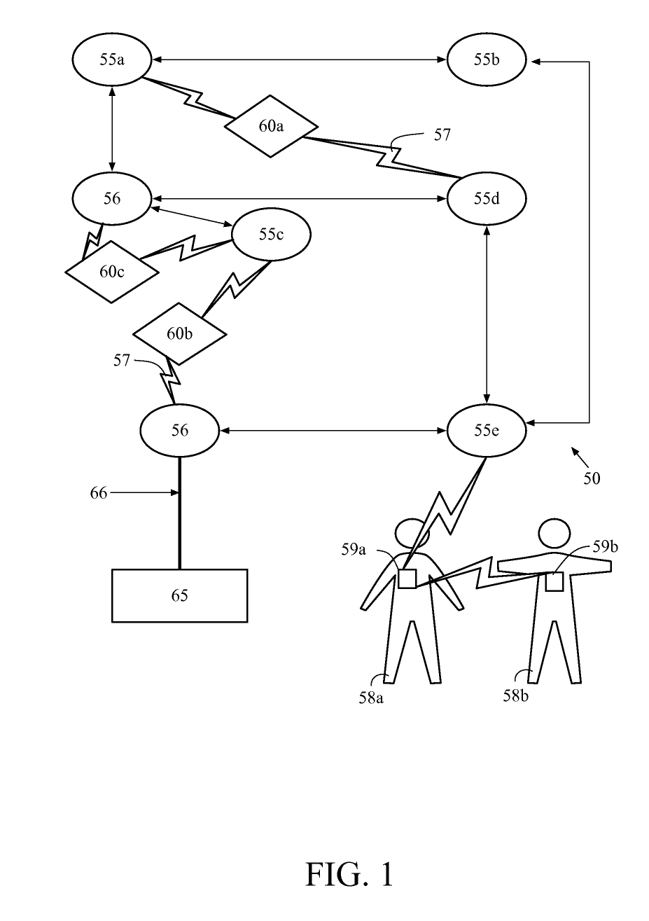

As shown in FIGS. 1-3, a system for improving tracking indoor or outdoor object and/or person movement using workflow context information is generally designated 50. The system 50 is capable of analyzing an interaction between objects, individuals 58 and/or objects 100. The system 50 preferably includes a plurality of sensors 55, a plurality of bridges 56, a plurality of communication devices 59, a plurality of tags 60, and at least one context-aware location engine 65. The sensors 55 alternatively form a mesh network for receiving signals from the communication devices 59 and tags 60. Alternatively, the sensors 55 transmit directly to the bridge 56 for further transmission to the context-aware location engine 65. One example of the components of the system 50 is disclosed in U.S. Pat. No. 7,197,326, for a Wireless Position Location And Tracking System, which is hereby incorporated by reference in its entirety. A more specific example of the sensors 55 is disclosed in U.S. Pat. No. 7,324,824, for a Plug-In Network Appliance, which is hereby incorporated by reference in its entirety. Another wireless tracking system and method is Perkins et al., U.S. patent application Ser. No. 12/885,509, filed on Sep. 18, 2010, for a Wireless Tracking System And Method Utilizing Near Field Communication Devices, which is hereby incorporated by reference in its entirety. Yet another wireless tracking system and method is Perkins et al., U.S. Pat. No. 8,285,564, for a Wireless Tracking System And Method For Analyzing An Interaction Between Objects, which is hereby incorporated by reference in its entirety.

The system 50 is preferably employed at a facility 70 such as a hospital, business office, factory, home, and/or government agency building. The system 50 is preferably utilized to track and locate various resources (including persons) positioned throughout the facility 70 in order to improve tracking object/person movement using workflow context information. The communication devices 59 and tags 60 preferably continuously transmit signals on a predetermined time cycle, and these signals are received by sensors 55 positioned throughout the facility 70. Alternatively, the tags 60 and communication devices 59 transmit signals in a random, ad-hoc or dynamic manner, and these signals are received by the sensors 55 positioned throughout the facility 70. The sensors 55 preferably transmit the data from the communication devices 59 and tags 60 to a bridge 56 for transmission to the context-aware location engine 65. If a sensor 55 is unable to transmit to a bridge 56, the sensor 55 may transmit to another sensor 55 in a mesh network for eventual transmission to a bridge 56. In a preferred embodiment, a transmission may be sent from a transmission distance of six sensors 55 from a bridge 56. Alternatively, a transmission is sent from a transmission distance ranging from ten to twenty sensors 55 from a bridge 56. The context-aware location engine 65 preferably continuously receives transmissions from location tracking system formed by the sensors 55 via the bridges 56 concerning the movement of persons 58 bearing a communication device 59 and/or objects 100 bearing a tag 60 within the facility 70. The context-aware location engine 65 processes the transmissions from the sensors 55 and to generate filter location estimations for the objects or persons 58 bearing a communication device 59 or objects 100 bearing a tag 60, within the facility 70.

The real-time location information for each of the objects is preferably displayed on an image of a floor plan of the facility 70, or if the facility 70 has multiple floors, then on the floor plan images of the floors of the facility 70. The floor plan image may be used with a graphical user interface of a computer, personal digital assistant, or the like so that an individual of the facility 70 is able to quickly locate objects 100 within the facility 70.

As shown in FIG. 1, the system 50 utilizes sensors 55 to monitor and identify the real-time position of individuals bearing or integrated with communication devices 59. The sensors 55a-f preferably wirelessly communicate with each other (shown as double arrow lines) and with the context-aware location engine 65 through a wired connection 66 via at least one bridge 56, such as disclosed in the above-mentioned U.S. Pat. No. 7,324,824 for a Plug-In Network Appliance. The communication devices 59 and tags 60 preferably transmit wireless signals 57 which are received by the sensors 55a-e, which then transmit signals to bridges 56 for eventual transmission to the context-aware location engine 65. The context-aware location engine 65 is preferably located on-site at the facility 70. However, the system 50 may also include an off-site context-aware location engine 65, not shown.

In a preferred embodiment, the communication device 59 preferably operates at a short range communication format of magnetic induction, 9 kHz, <125 kHz, 125 kHz RFID, 13.56 MHz, 433 MHz, 433 MHz RFID, and 900 MHz RFID, and preferably at a bit rate of less 256 kilobits per second or approximately 426 kilobits per second. The communication format is preferably IEEE Standard 802.15.4. Further, the communication device 59 also operates using a medium range communication format.

The medium range communication format can include ZIGBEE, BLUETOOTH, BLUETOOTH low energy, WiFi, Low-power WiFi, Ultrasound and Infrared communication formats. Those skilled in the pertinent art will recognize that other communication formats may be used with departing from the scope and spirit of the present invention. The medium range communication format also allows the communication device 59 to communicate with the sensors 55 to transmit interaction information.

In an alternative embodiment, each communication device 59 and tag 60 preferably transmits a radio frequency signal of approximately 2.48 GigaHertz (“GHz”). The communication format is preferably IEEE Standard 802.15.4. Alternatively, each communication device 59 and tag 60 transmits an infrared signal or an ultrasound signal. Each device preferably contains a low-power, medium-range (1 foot to 30 feet) wireless communication system. Such wireless communication systems include ZIGBEE, BLUETOOTH, Low-Power BLUETOOTH, WiFi or Low-Power WiFi, Ultra Wide Band (“UWB”), Ultrasound and Infrared communication systems. The wireless communication system is used to exchange device specific information after the low-power short-range system has indicated that an interaction has occurred. Those skilled in the pertinent art will recognize that the wireless communication system can also be used independent of the low-power short-range system for other wireless communication applications such as location and tracking, sense and control, building automation, smart energy, telecom applications, consumer building automation, remote control applications, home health care, personal fitness, personal wellness, and many other applications. The tags 60 may be constructed with an asset theft protection system such as disclosed in Baranowski et al., U.S. Pat. No. 7,443,297 for a Wireless Tracking System And Method With Optical Tag Removal Detection, which is hereby incorporated by reference in its entirety. The tags 60 and communication devices 59 may be designed to avoid multipath errors such as disclosed in Nierenberg et al., U.S. Pat. No. 7,504,928 for a Wireless Tracking System And Method Utilizing Tags With Variable Power Level Transmissions, and Caliri et al., U.S. Patent Publication Number 2008/0012767 for a Wireless Tracking System And Method With Multipath Error Mitigation, both of which are hereby incorporated by reference in their entireties.

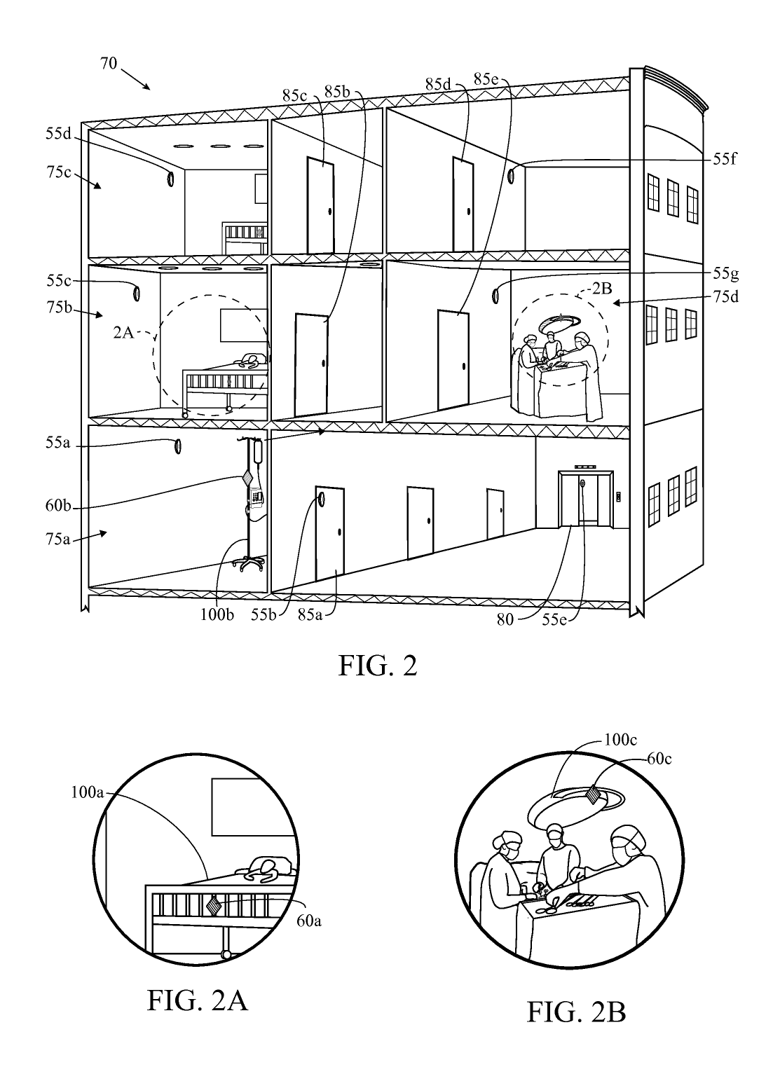

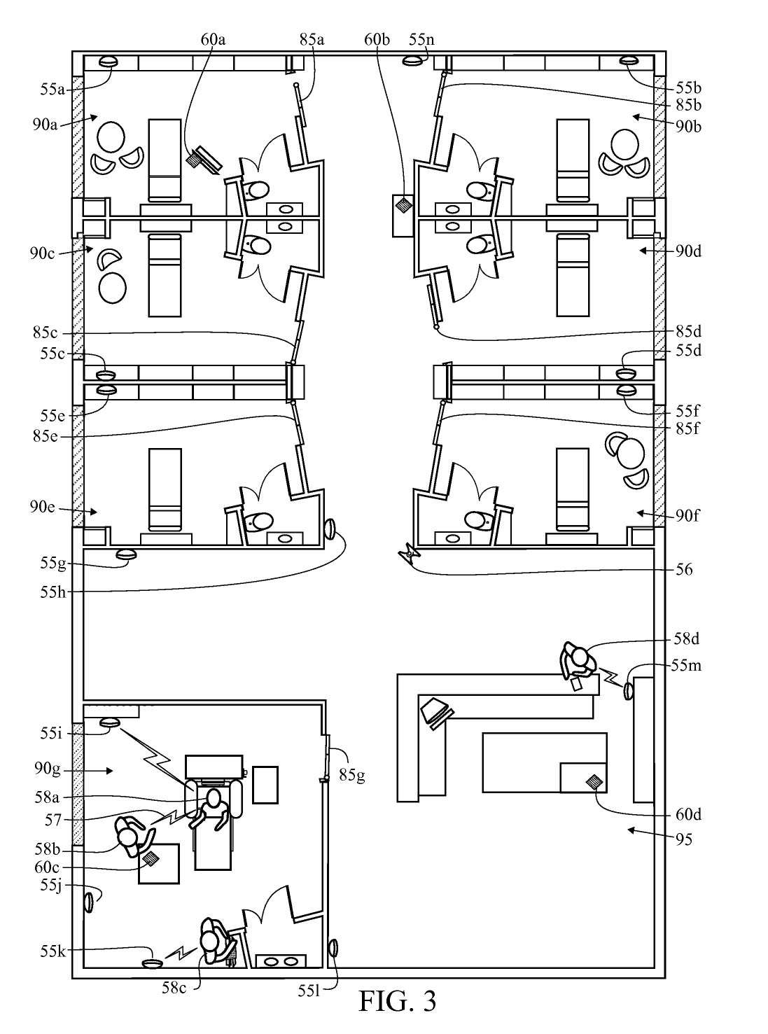

As shown in FIGS. 2, 2A 2B and 3, the facility 70 is depicted as a hospital. The facility 70 has multiple floors 75a-c. Each floor 75a, 75b and 75c has multiple rooms 90a-i, with each room 90 accessible through a door 85. Positioned throughout the facility 70 are sensors 55a-o for obtaining readings from communication devices 59 and tags 60 attached to people or objects. A bridge 56 is also shown for receiving transmissions from the sensors 55 for forwarding to the context-aware location engine 65. For example, as shown in FIG. 2, the system 50 determines that individuals 58a, 58b and 58c are located in a surgery room and are using device 100c, which is a surgical kit. The context-aware location engine 65 analyzes the interaction by monitoring the duration of the interaction, the devices 100 utilized, the location of the interaction (surgery), the previous location of the individuals 58 (possibly a surgical prep room) and additional factors. The context-aware location engine 65 is configured to maintain and track workflow specific usage information about each of a plurality of locations in the facility 70.

In another example, as shown in FIG. 3, individuals 58a, 58b and 58c are located in a patient's room and are using a medical object with an attached tag 60c, which is a patient monitoring unit. In this example, individual 58a is a patient, individual 58b is a physician, and individual 58c is a nurse. The communication device 59 of each individual 58a, 58b and 58c communicates with the other communication devices 59 using a short range communication format as discussed above. In such a situation, each near-field communication device 59 registers the short range beacons transmitted by other near-field communication devices 59. Additionally, interaction information may be transferred between the communication devices 59 using a medium range communication format as discussed above. Further, one, two or all of the communication devices 59 transfer interaction information to at least one sensor 55 using a medium range communication format. The sensor 55 then transmits the interaction information to the context-aware location engine 65. The context-aware location engine 65 analyzes the communication interaction information received by the sensor 55 by monitoring the duration of the communication interaction, the objects 100 utilized, the location of the communication interaction (patient's room), the previous location of the individuals 58 and additional factors. The context-aware location engine 65 preferably uses this data to generate a plurality of filtered location estimates for the objects/persons associated with the communication devices.

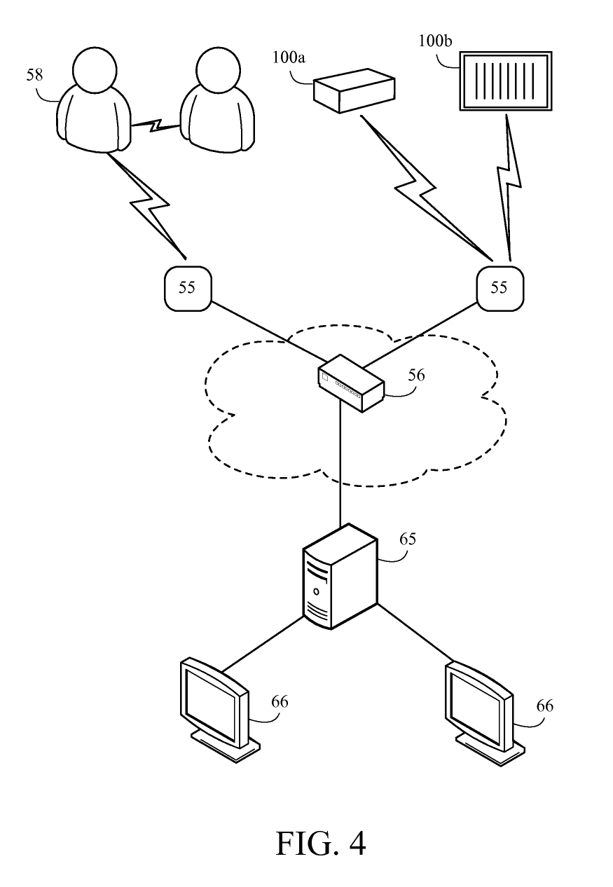

FIG. 4 illustrates a preferred architecture of the system 50. For description purposes, the information providers are set forth on one side of the network and the operations is set forth on the other side of the network. However, those skilled in the pertinent art will recognize that the illustrated architecture of the system 50 is not meant to limit any physical relationship between information providers and operations. In fact, an individual 58 could be tracked while accessing information from an object 100 such as a computer 66 in operations. The information providers include individuals 58 that wear communication devices 59, equipment 100a bearing tags 60, sterilizable equipment 100b bearing sterilizable tags 60, and the like. The communication device 59 may utilize an antenna structure such as disclosed in U.S. patent application Ser. No. 12/554,814, for Antenna Diversity For Wireless Tracking System And Method, filed on Sep. 4, 2009, which is hereby incorporated by reference in its entirety. A description of sterilizable tags 60 and system is found in Caliri et al., U.S. Pat. No. 7,636,046 for Wireless Tracking System And Method With Extreme Temperature Resistant Tag, which is hereby incorporated by reference in its entirety. Another description of a sterilizable tag 60 and system is found in Perkins et al., U.S. Pat. No. 7,701,334 for Wireless Tracking System And Method For Sterilizable Object, which is hereby incorporated by reference in its entirety. A bridge 56 acts as an intermediary between the information providers and operations. The bridge 56 communicates information to the generate a plurality of filtered location estimates for the plurality of communication devices 65 which analyzes the information to track a location history and a plurality of workflow stages of each the objects/persons being tracked.

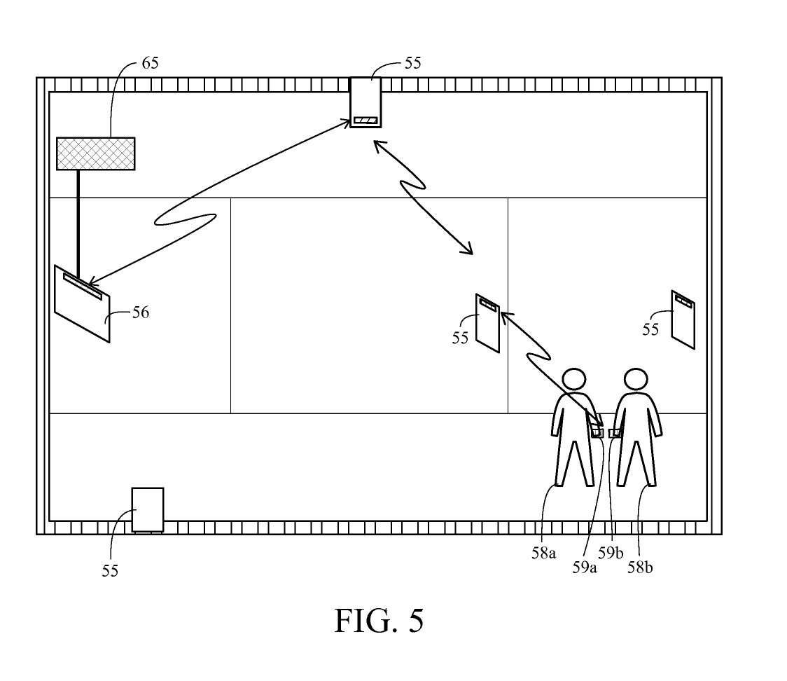

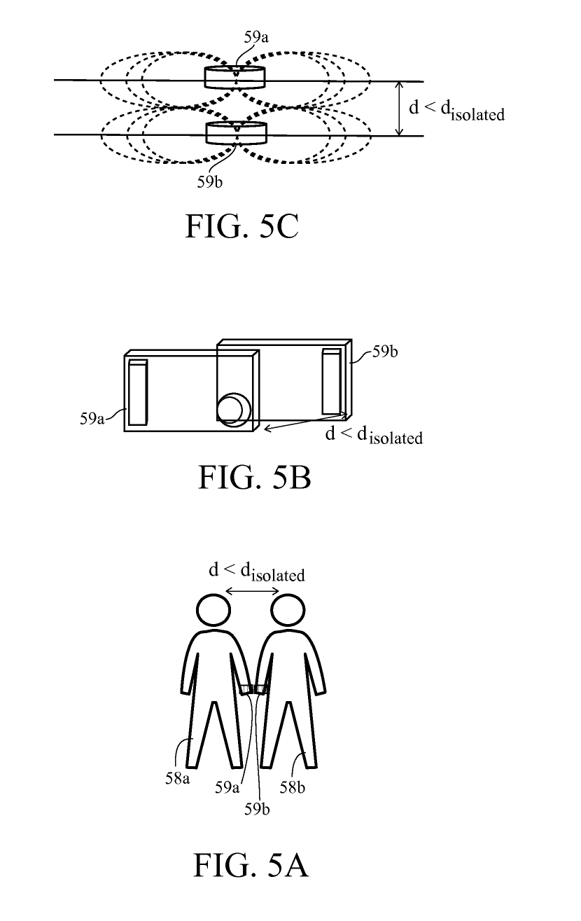

A block diagram of a system utilizing communication is illustrated in FIG. 5. In FIG. 5, two individuals 58a and 58b are in proximity in order to “mash-up” and have a valid communication interaction with each individual's communication devices 59a and 59b using a short range communication format as discussed above. A signal is transmitted from one of the individual's 58a communication device 59a to a sensor 55 of a utilizing a medium range communication format as discussed above. The signal contains information pertaining to the communication interaction. The sensor 55 transmits the signal through the sensor to a bridge 56 for further transmission to an context-aware location engine 65.

FIGS. 5A, 5B and 5C illustrate a valid communication link which occurs when the two communication devices 59a and 59b are within a predetermined distance of each other (d<d isolated). Preferably the distance is ten centimeters or less. Most preferably there is a physical touch between the two communication devices. Requiring such proximity allows for power savings since the transmission field for each of the communication devices 59a and 59b is a minimal amount. If the communication device 59 were to transmit using a typical RFID signal or BLUETOOTH signal, then the power consumption would be greater. Those skilled in the art will recognize that the tag 60 and communication device 59 may be the same physical device with circuitry for both applications.

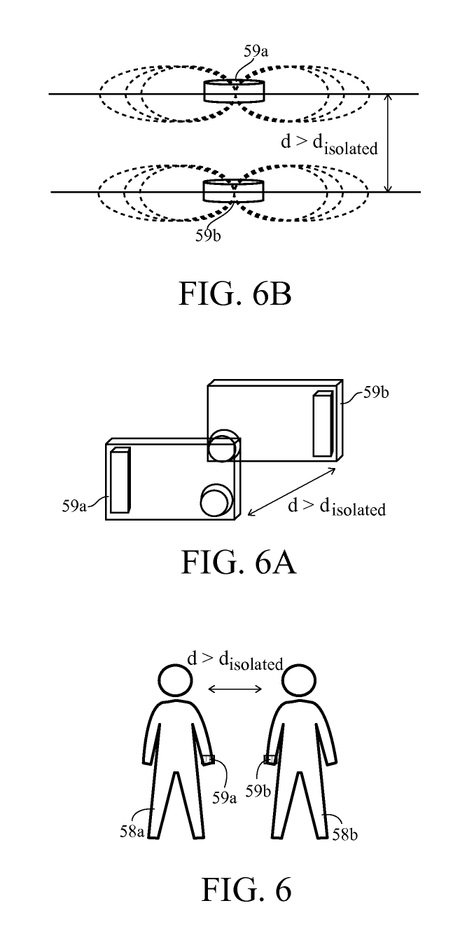

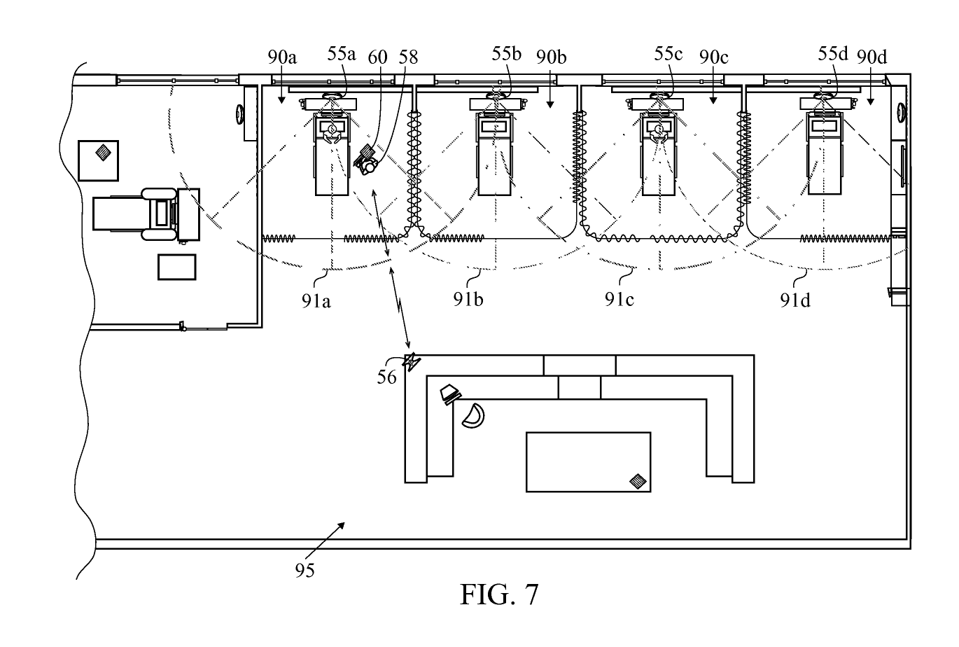

FIGS. 6, 6A and 6B illustrate an unsuccessful communication link. In this situation, the two communication devices 59a and 59b are not within a predetermined distance of each other (d>d isolated). Preferably, the distance is more than ten centimeters. In such a situation, there is no communication interaction. Thus, even though the communication devices 59a and 59b are transmitting signal beacons, the individuals 58a and 58b are too far apart to detect a beacon signal from the other communication device 59.

The communication device 59 preferably includes a microcontroller, a first transceiver for transmitting at the short range communication format, a second transceiver for transmitting at the medium range communication format, a memory, and a power supply. Alternatively, the communication device 59 includes a microcontroller, a first transceiver for transmitting at the short range communication format, a memory, and a power supply. The transmissions are transmitted through the transceivers. The power supply provides power to the components of the communication device 59. All of the components are preferably contained within a housing. A tag 60 preferably has the same components and structure of the communication device 59 except the tag 60 preferably only operates using the medium range communication format.

In one embodiment, the communication interaction is utilized to authenticate a bearer of a communication device 59 for access to at least one of or a combination of a computer, medical equipment, a protected area of the facility, a medication drawer, or a patient's room. For example, an individual 58 bearing the communication device 59 is a physician and the physician 58 is granted access to a patient's room through a communication interaction with a communication device 59 on a door of the patient's room. In one example, the patient has a highly contagious disease and the tracking the workflow of access to the patient's room allows a hospital to know who has been exposed to the patient.

In another embodiment, the communication interaction is utilized to track proper hand washing at a hospital. In this example, a device 59 is positioned near a hand washing station for sterilizing hospital personal prior to surgery or similar procedures that require sterilization. When a bearer of a device 59 sterilizes his/her hands at the station, the interaction of the devices 59 is recorded and transmitted to a sensor 55 for recordation at an information engine 65. In this manner, the hospital has a record to demonstrate that proper sterilization was performed prior to surgery or similar procedure requiring sterilization.

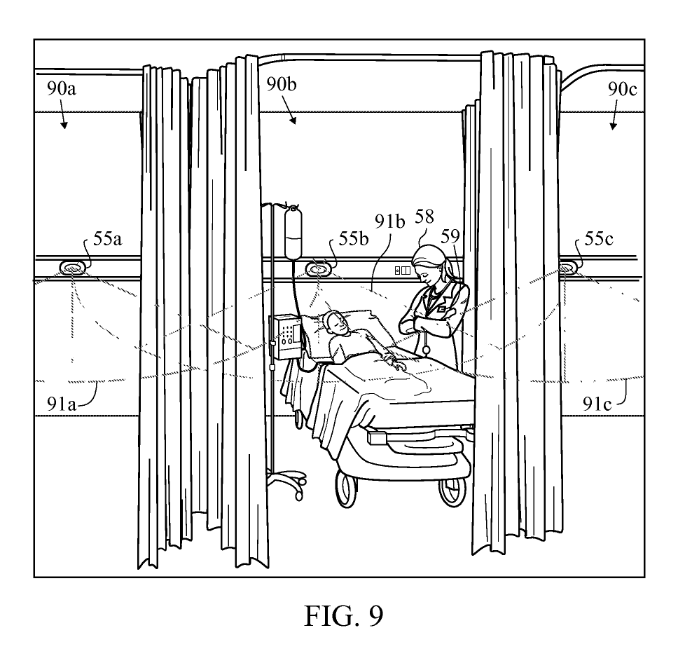

An emergency room 95 of a hospital is shown in FIGS. 7 and 9. The emergency room 95 has multiple bays 90a-d for treating patients. Curtains usually separate the bays 90 from each other. Each bay 90 preferably has a beacon device 55a-55d, which preferably transmits a beacon on a low power short-range wireless communication format, typically within a ten foot range. Thus, some of the beacon signals overlap adjacent bays 90. For example, the beacon transmitted from beacon transmitter 55a extends into bay 90a and into bay 90b. A communication device 59 worn by a physician 58 in bay 90b will most likely receive beacon transmission from the beacon transmitter 55b, the beacon transmitter 55a in bay 90a and the beacon transmitter 55c in bay 90c.

The beacon transmitters 55a-55d preferably operate at a short range communication format such as magnetic induction, 9 kHz, <125 kHz, 125 kHz RFID, 13.56 MHz, 433 MHz, 433 MHz RFID, and 900 MHz RFID, and preferably at a bit rate of less 256 kilobits per second or approximately 426 kilobits per second. The communication format is preferably IEEE Standard 802.15.4. Further, beacon transmitters 55a-55d may also operate using a medium range communication format. The medium range communication format can include ZIGBEE, BLUETOOTH, BLUETOOTH low energy, WiFi, Low-power WiFi, Ultrasound and Infrared communication formats.

The communication device 59 worn by a physician 58 receives the beacon transmissions from some or all of the beacon transmitters 55a-55d. A signal strength for each beacon transmission received by the communication device 59 is preferably determined along with an identification of the beacon transmission. The location of the communication device 59 is preferably determined based on the received beacon transmission using a method such as disclosed in Perkins, U.S. patent application Ser. No. 13/244,257, for a Wireless Tracking System And Method Utilizing Variable Location Algorithms, filed on Sep. 23, 2011, which is hereby incorporated by reference in its entirety.

In a preferred embodiment, the communication device 59 worn by a physician 58 preferably transmits the interaction data to a bridge 56 using a medium range communication format such as ZIGBEE, BLUETOOTH, BLUETOOTH low energy, WiFi, Low-power WiFi, Ultrasound or Infrared communication formats. Alternatively, the interaction data is transmitted to a bridge 56 by a beacon transmitter 55a-d using a medium range communication format such as ZIGBEE, BLUETOOTH, BLUETOOTH low energy, WiFi, Low-power WiFi, Ultrasound or Infrared communication formats. Yet, in a further embodiment, the communication device 59 worn by a physician 58 preferably transmits the interaction data to a bridge 56 using a short range communication format such as magnetic induction, 9 kHz, <125 kHz, 125 kHz RFID, 13.56 MHz, 433 MHz, 433 MHz RFID, and 900 MHz RFID.

The context-aware location engine 65 preferably continuously receives transmissions from the bridges 56 concerning the movement of persons 58 bearing a communication device 59. The context-aware location engine 65 processes the transmissions from and monitors a real-time workflow for persons 58 bearing a communication device 59 within the facility 70. The real-time location information for each of the objects is preferably displayed on an image of a floor plan of the facility 70, or if the facility 70 has multiple floors, then on the floor plan images of the floors of the facility 70. The floor plan image may be used with a graphical user interface of a computer, personal digital assistant, or the like so that an individual of the facility 70 is able to be quickly located.

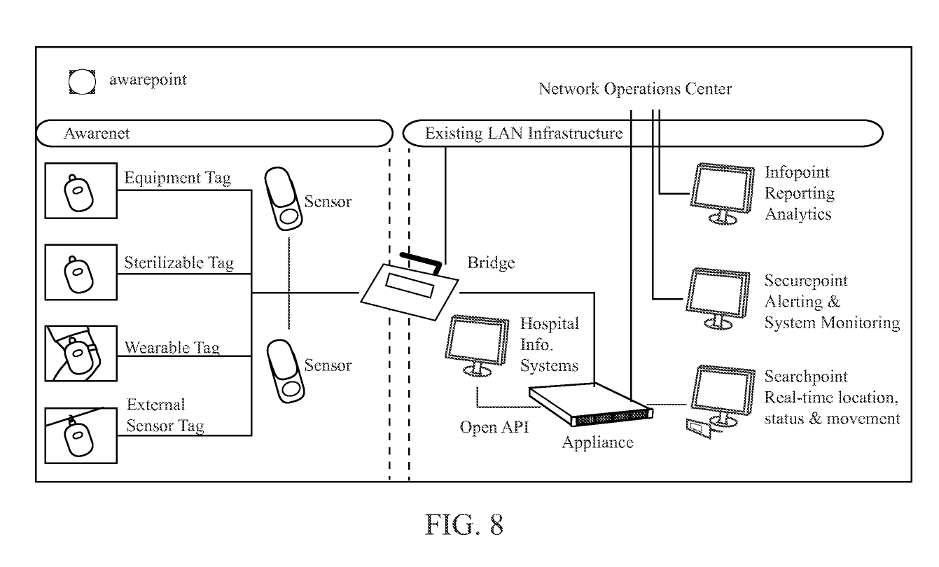

FIG. 8 is a block diagram of a system for determining a real-time location of an object. Sensors receive the messages from the broadcasting tags through attached different antennas, calculate the signal strength, and decide which signal strength to use. The signal strength information is routed to the server for location processing. Bridge/appliance/server devices received signal strength information from the high definitions sensors and make location decisions. The tag sends broadcast messages preferably using ZIGBEE based wireless transmissions. The sensors receive the ZIGBEE based wireless transmissions preferably through two spatially and angularly diverse antennas. Software on each sensor preferably identifies and matches the sending tag and received signal strength readings. Software on each sensor preferably makes local decisions on the final signal strength value for the transponder. Each sensor preferably sends the signal strength information to the appliance through a wireless ZIGBEE based wireless transmission network. The tags and sensors communicate to the bridges preferably through a ZIGBEE based wireless transmission network. The location of the tags is preferably calculated by using the paired signal strength between tags and the sensors that hear the tag. Time slicing is also utilized in determining a real-time location of the object within an indoor facility by making time slots available in each antenna.

A patient wears, or has attached, a patient tag 60a and a plurality of medical devices bearing or integrated with tags 60b. Such healthcare devices may include blood pressure monitors, dialysis devices, respiration aids, oxygen tanks, wheelchairs, and the like, and all may act as nodes in a mesh network. The plurality of network monitors preferably utilize ZIGBEE networking standards and technology, such as disclosed at zigbee.org, which pertinent parts are hereby incorporated by reference.

Another description of a tracking system is found in Caliri et al., U.S. Patent Number 7636046 for Wireless Tracking System And Method With Extreme Temperature Resistant Tag, which is hereby incorporated by reference in its entirety. Another description of a tracking system is found in Perkins et al., U.S. Pat. No. 7,701,334 for Wireless Tracking System And Method For Sterilizable Object, which is hereby incorporated by reference in its entirety. Another description of a tracking system using tags is found in Hertlein et al., U.S. patent application Ser. No. 13/371,416, filed on Feb. 11, 2012, for Sterilizable Wireless Tracking And Communication Device And Method For Manufacturing, which is hereby incorporated by reference in its entirety. In another embodiment, the wireless communication devices, are used with or as near-field communication devices such as disclosed in Perkins, U.S. Pat. No. 7,941,096 for Wireless Tracking System And Method Utilizing Near-Field Communication Devices, which is hereby incorporated by reference in its entirety. In another embodiment, the wireless communication devices, are used with or as back-hauling communication devices such as disclosed in Perkins, U.S. Pat. No. 8,040,238 for Wireless Tracking System And Method For Backhaul Of Information, which is hereby incorporated by reference in its entirety. The present invention may utilize location algorithms such as disclosed in Perkins, U.S. patent application Ser. No. 13/244,257, for a Wireless Tracking System And Method Utilizing Variable Location Algorithms, filed on Sep. 23, 2011, which is hereby incorporated by reference in its entirety. The present invention may be utilized with peer-to-peer interactions and workflow such as disclosed in Perkins, U.S. Pat. No. 8,285,564 for a Wireless Tracking System And Method For Analyzing An Interaction Between Objects, which is hereby incorporated by reference in its entirety.

The present invention may be utilized with peer-to-peer interactions and workflow such as disclosed in Perkins, U.S. Pat. No. 8,285,564 for a Wireless Tracking System And Method For Analyzing An Interaction Between Objects, which is hereby incorporated by reference in its entirety. The present invention may utilize a low frequency magnetic induction positioning system such as disclosed in Perkins et al., U.S. patent application Ser. No. 13/792,195, for a Low Frequency Magnetic Induction Positioning System And Method, filed on Mar. 11, 2013, which is hereby incorporated by reference in its entirety.

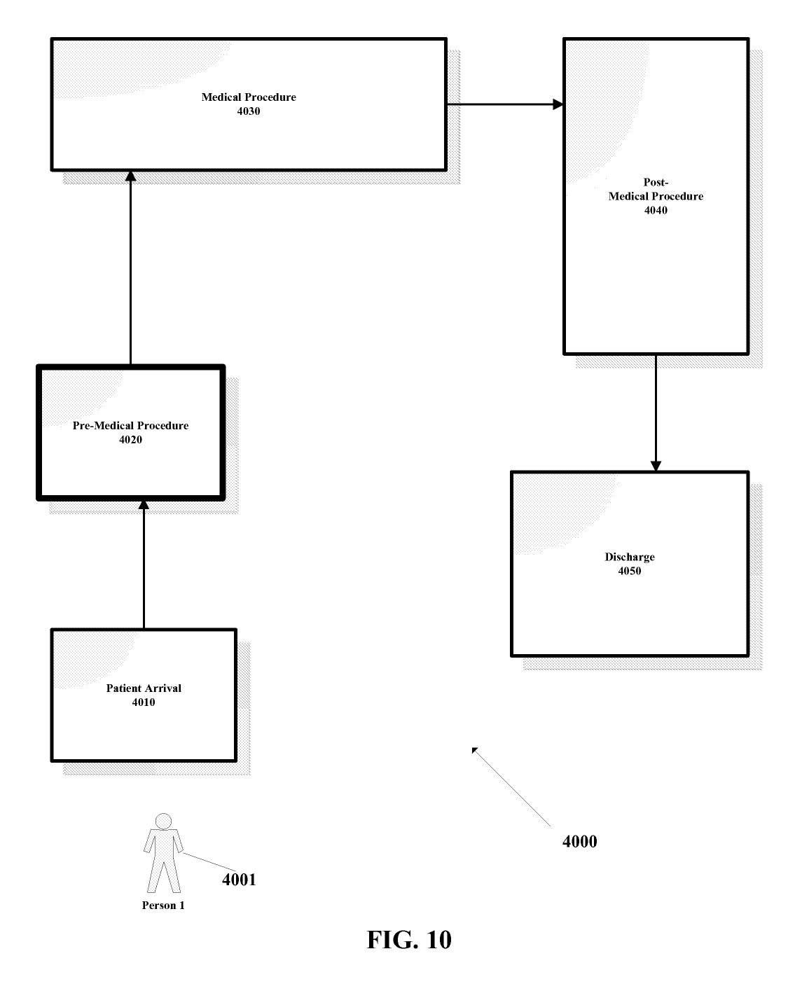

As shown in FIG. 10, one embodiment of a workflow for a patient in a medical facility is generally designated 4000. The workflow for the patient 4001 begins at patient arrival stage 4010. The patient 4001 is preferably associated with a communication device 58 to track the patient 4001 throughout the medical facility. The next stage is a patient in preparation for a medical procedure stage 4020. The next stage is a patient in a medical procedure stage 4030. The next stage is a patient in post-medical procedure stage 4040. The final stage is a patient departure/discharge stage 4050. Sensors 55 throughout the facility communicate data to the context aware location engine 65. The context aware location engine 65 receives from the location tracking sub-system initial location estimations for the patient 4001. This information is communicated from the communication device 58 worn by the patient, which sends signals to the sensors 55. The context aware location engine 65 generates a plurality of filtered location estimates for the patient 4001 in order to improve tracking in the medical facility. The context aware location engine 65 can determine an estimate of the location of the patient 4001, based on at least one or more of customary workflows, the time of arrival of the patient, the progress of the patient 4001, the progress of medical procedures commenced before the arrival of the patient 4001, and the number of staff working that day. Those skilled in the pertinent art will recognize that other factors may be utilized by the context aware location engine 65 in generating the plurality of filtered location estimates for the patient 4001.

As previously mentioned, the workflow is at least one of a series of locations, a series of states, a series of dwell times, a series of interactions, a series of emergency department milestones, a series of surgical milestones, or a series of detected events. A series of emergency department milestones is at least one of a physician call, an EMS call, an arrival/sign-in, a nurse saw, a doctor saw, an entered ED, a departed ED, a bed request, a bed check, a bed ready, a fully registered, a triaged, a quick registered, a dispo ordered, and a floor report. A series of surgical milestones is at least one of case created, a check-in, a ready for pre-op, a pre-op declined, a pre-op accepted, an arrived pre-op room, a ready for pre-op nurse, a patient prepped, a left pre-op, an inpatient ready, an ED ready, an arrived OR, a procedure start, a procedure end, a ready for PACU, a ready for ICU, a ready for post-op, a PACU decline, a post-op declined, a PACU accepted, a post-op accepts OR and a departed OR.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

1. A system for improving tracking indoor or outdoor object movement using workflow context information, the system comprising:
a location tracking system comprising a plurality of sensors located in a facility for real-time location tracking of persons and/or objects;
a plurality of communication devices, each of the plurality of communication devices associated with an object or a person, each of the plurality of communication devices configured to transmit a signal to at least one of the plurality of sensors; and
a context-aware location engine in communication with the location tracking system, the context-aware location engine configured to receive from the location tracking system a plurality of initial location estimations for the plurality of communication devices and the context aware location engine configured to generate a plurality of filtered location estimates for the plurality of communication devices based on at least one of a standard workflow, specific usage information for a plurality of objects in the facility, location classification, and information from a plurality of communication interactions for interactions between the plurality of communication devices.

2. The system according to claim 1 wherein the context aware location engine comprises the standard workflow that is known a priori.

3. The system according to claim 1 wherein the context aware location engine comprises the standard workflow that is customary.

4. The system according to claim 3 wherein the workflow is at least one of a series of locations, a series of states, a series of dwell times, a series of interactions, a series of milestones, or a series of detected events.

5. The system according to claim 4 wherein the series of milestones is at least one of a physician call, an EMS call, an arrival/sign-in, a nurse saw, a doctor saw, an entered ED, a departed ED, a bed request, a bed check, a bed ready, a fully registered, a triaged, a quick registered, a dispo ordered, and a floor report.

6. The system according to claim 4 wherein the series of milestones is at least one of case created, a check-in, a ready for pre-op, a pre-op declined, a pre-op accepted, an arrived pre-op room, a ready for pre-op nurse, a patient prepped, a left pre-op, an inpatient ready, an ED ready, an arrived OR, a procedure start, a procedure end, a ready for PACU, a ready for ICU, a ready for post-op, a PACU decline, a post-op declined, a PACU accepted, a post-op accepts OR and a departed OR.

7. The system according to claim 1 wherein the role of each object associated with each of the plurality of communication devices is maintained and tracked by the context-aware location engine.

8. The system according to claim 1 wherein the object is selected from the group of a patient, a nurse, a physician, housekeeping member, a technician, a transport, a room, a fix location asset, and a moveable asset.

9. The system according to claim 8 wherein the context-aware location engine is configured to track a location history and a plurality of workflow stages of each the objects being tracked.

10. The system according to claim 4 wherein the facility is a hospital and the plurality of workflow stages of patient under tracking comprises at least one of a patient arrival stage, a patient in preparation for a medical procedure, a patient in a medical procedure stage, a patient in post-medical procedure stage, and a patient departure.

11. The system according to claim 1 wherein the context-aware location engine is configured to maintain and track workflow specific usage information about each of a plurality of locations in the facility.

12. The system according to claim 11 wherein the facility is a hospital and the plurality of workflow specific usage of the locations comprise at least one of a patient room, a nurse station, a hallway, a storage room, a clean utility room, a dirty utility room, a hallway, an exit, a stairway, a restroom, and an office.

13. The system according to claim 1 wherein the context-aware location engine is configured to maintain and track the real-time user input information of each the objects or persons being tracked.

14. The system according to claim 13 wherein the facility is a hospital and the real-time user input information comprises at least one of staff marking a patient arrival and staff assigning a room to a patient.

15. The system according to claim 1 wherein the context-aware location engine is configured to maintain and track a plurality of real-time interactions between moveable and fixed objects under tracking.

16. The system according to claim 15 wherein the facility is a hospital and plurality of real-time interactions between moveable and fixed objects under tracking comprises at least one of staff or patient interactions with fixed known location objects.

17. The system according to claim 1 wherein the context-aware location engine is configured to maintain and track a plurality of real-time interactions between moveable and movable objects under tracking.

18. The system according to claim 17 wherein the facility is a hospital and plurality of real-time interactions between moveable and moveable objects under tracking comprises at least staff and patient interactions.
